(19) United States
(12) Patent Application Publication
(10) Pub. No.: US 2012/0055523 A1
(43) Pub. Date: Mar. 8, 2012

(54) MOBILITY DEVICE

(76) Inventor: R. Gary Diaz, Highland Park, IL (US)

(21) Appl. No.: 13/229,337

(22) Filed: Sep. 9, 2011

Related U.S. Application Data
(63) Continuation of application No. 12/799,715, filed on Apr. 30, 2010, now abandoned.
Application No. 12/799,715 is a continuation-in-part of application No. 11/705,394, filed on Feb. 12, 2007, now abandoned.
Application No. 11/705,394 is a continuation of application No. 11/218,354, filed on Sep. 2, 2005, now abandoned.

(51) Int. Cl. A61H 3/02; B21D 31/00

(52) U.S. Cl. 135/71; 72/362

(57) ABSTRACT

An improved mobility device for assisting in the movement of the limbs is set forth. The device includes an arm support section. A vertical shaft is also provided. A handgrip section connects the arm support section to an upper angled section of the vertical shaft. The handgrip section is angled below a vertical plane perpendicular to the shaft. The handgrip section is substantially centered over the vertical shaft.

### REFERENCE TO RELATED APPLICATIONS

This application is a continuation of U.S. application Ser. No. 12/799,715 filed 30 Apr. 2010 which is a continuation-in-part of U.S. patent application Ser. No. 11/705,394 filed 12 Feb. 2007, entitled “Mobility Device”, which is a continuation of U.S. patent application Ser. No. 11/218,354 filed 2 Sep. 2005, entitled “Mobility Device”, now abandoned, both incorporated herein by reference.

### BACKGROUND

1. Technical Field

This invention relates to an improved mobility device for enhancing movement of a user limited by illness or injury, and for improving the movement of a user with continued use, such as, for example, a patient with a gait disorder.

2. Description of Related Art

Mobility devices, such as canes and crutches, are well known for their ability to assist users having impairments to walking due to injury, illness, or loss of limb.

One such crutch, for example, is designed to place the supporting point of the walking aid further forward on the floor, giving the user a greater feeling of security and lengthening his steps, as described in U.S. Pat. No. 5,860,439 to Ostertag.

Another crutch, for example, can be formed of tubular metal suitably bent to form a forearm and hand support assembly wherein the hand support assembly includes a horizontal handle section extending forwardly from a vertical shaft as discussed in U.S. Pat. No. 5,193,597 to Razny Jr.

Further, a variety of crutches bent to form hand grip sections with different configurations are shown, for example, in JP 2005-40569.

### SUMMARY OF THE INVENTION

An improved mobility device is set forth. The device includes a shaft having a lower vertical section and an upper, angled section. The shaft is connected to a handgrip section. The handgrip section is angled downwardly from a plane perpendicular to the plane of the lower vertical section of the shaft and disposed substantially centrally over the lower vertical section. The handgrip section is connected to an extension section. The extension section is angled outwardly, opposite the direction of the upper section of the shaft, and at an angle approximately twice the downward angle of the handgrip section. The extension section is connected to a forearm support cradle. The forearm support cradle is formed substantially perpendicular to the extension section, and disposed substantially to at least one of a right side and a left side of the extension section to accommodate at least one of a left hand grip and a right hand grip.

In an embodiment a base portion of the angled section forms an angle of approximately fifty eight degrees with a plane perpendicular to the shaft.

In another embodiment a base portion of the angled section curves back toward the vertical plane of the shaft.

An improved mobility device for assisting in the movement of the limbs is also set forth. The device includes an arm support section and a vertical shaft. A handgrip section is provided, and is connected to the arm support section and to an upper angled section of the vertical shaft. The handgrip section is angled below a vertical plane perpendicular to the shaft, and is substantially centered over the vertical shaft.

A method of forming an improved mobility device is also set forth. The method includes the following steps. First, a tubular aluminum bar is provided. Next, the bar is bent outwardly, away from a central plane of a shaft of the bar to form an upper angled shaft portion. The bar is then curved back toward the central plane of the bar at an angle below a plane perpendicular to the central plane to form a handgrip section, wherein the handgrip section is substantially centered over the shaft. The bar is then bent to form an arm support section.

### BRIEF DESCRIPTION OF THE DRAWINGS

FIG. 1 illustrates an improved mobility device constructed in accordance with the principles herein.

### DESCRIPTION

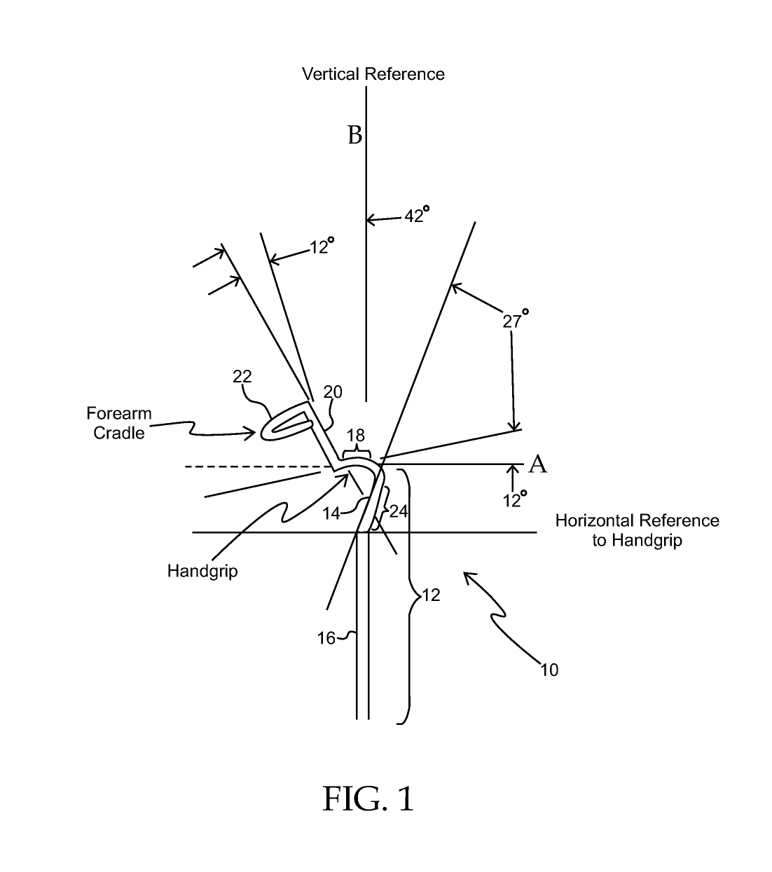

As illustrated in FIG. 1, an improved mobility device, shown generally at 10, includes a shaft 12. The shaft 12 can be formed of a suitable material or combination of materials such as, for example, tubular aluminum. The shaft includes an upper, angled portion 14 and a lower vertical section 16. The upper angled portion 14 of the shaft is angled outwardly from the lower vertical section 16.

The shaft 12 is connected via the upper angled portion 14 to a handgrip section 18. The handgrip section 18 is angled downwardly from a plane, such as plane A of FIG. 1, perpendicular to the plane; such as plane B of FIG. 1 of the lower vertical section 16 of the shaft 12. The handgrip section 18 is disposed substantially centrally over the lower vertical section 16. The handgrip section 18 can include additional grip support, such as, for example, a plastic or foam grip to accommodate grip or comfort.

The handgrip section 18 is connected to an extension section 20. The extension section 20 is angled outwardly, opposite the direction of the upper section 14 of the shaft 12, and at an angle of more than twice the downward angle of the handgrip section 18. For example, the downward angle of the handgrip section 18 can range from a slight angle to more than 20 degrees, and preferably around 12 degrees. Further, where the downward angle of the handgrip section 18 is, for example, 12 degrees, then the extension section 20 can be formed at approximately 40 degrees from the vertical plane B of the shaft 12. The extension section 20 is and connected to a forearm support cradle 22. The forearm support cradle 22 is formed substantially perpendicular to the extension section 20, and is disposed substantially to a right side or a left side of the extension section 20 to accommodate either a left hand grip or a right hand grip.

In an embodiment, a base portion 24 of the angled section 14 forms an angle of approximately fifty eight degrees with a plane perpendicular to the shaft.

In another embodiment a base portion 24 of the angled section 14 curves back toward the vertical plane of the shaft 12.

The improved design of the device is meant for rehabilitation. In other words, with proper use and treatment the need for the device for assisted mobility will eventually be eliminated. Thus, not only is the device meant to replace crutches, walkers, and other mobility devices, but also to give physicians and therapists a tool to return the user to the activities of daily living.

Although example implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

I claim as my invention:

1. An improved mobility device comprising:
a shaft having a lower vertical section and an upper, angled section connecting to a hand grip section;
the handgrip section angled downwardly from a plane perpendicular to the plane of the lower vertical section and disposed substantially centrally over the lower vertical section, the handgrip section connecting to an extension section;
the extension section angled outwardly opposite the direction of the upper section of the shaft, and at an angle approximately twice the downward angle of the handgrip section and connecting to a forearm support cradle; and
the forearm support cradle formed substantially perpendicular to the extension section, and disposed substantially to at least one of a right side and a left side of the extension section to accommodate at least one of a left hand grip and a right hand grip.

2. An improved mobility device as claimed in claim 1, wherein a base portion of the angled section forms an angle of approximately fifty eight degrees with a plane perpendicular to the shaft.

3. An improved mobility device as claimed in claim 1, wherein a base portion of the angled section curves back toward the vertical plane of the shaft.

4. An improved mobility device for assisting in the movement of the limbs comprising:
an arm support section;
a vertical shaft; and
a handgrip section connected to the arm support section and to an upper angled section of the vertical shaft, wherein the handgrip section is angled below a vertical plane perpendicular to the shaft, and wherein the handgrip section is substantially centered over the vertical shaft.

5. A method of forming an improved mobility device comprising the steps of:
providing a tubular aluminum bar,
bending the bar outwardly, away from a central plane of a shaft of the bar to form an
upper angled shaft portion;
curving the bar back toward the central plane of the bar at an angle below a plane perpendicular to the central plane to form a handgrip section, wherein the handgrip section is substantially centered over the shaft; and
bending the bar to form an arm support section.
